(19) United States
(12) Patent Application Publication
(10) Pub. No.: US 2025/0316719 A1
(43) Pub. Date: Oct. 9, 2025

(54) PT-ANCHORED OVER ZIRCONIUM PHOSPHATE FOR PROTON EXCHANGE MEMBRANE FUEL CELL APPLICATIONS

(71) Applicant: COUNCIL OF SCIENTIFIC AND INDUSTRIAL RESEARCH, New Delhi (IN)

(72) Inventors: Sachin KUMAR, Pune (IN); Sreekumar KURUNGOT, Pune (IN)

(21) Appl. No.: 18/866,189

(22) PCT Filed: May 12, 2023
(86) PCT No.: PCT/IN2023/050451

§ 371 Date: Nov. 15, 2024

(30) Foreign Application Priority Data
May 17, 2022 (IN) 202211028462

(51) Int. Cl. H01M 4/92; H01M 4/88; H01M 8/1004

(52) U.S. Cl. CPC H01M 4/925; H01M 4/881; H01M 4/885; H01M 8/1004

(57) ABSTRACT

The present invention provides a carbon-free electrocatalyst for oxygen reduction reaction (ORR) in polymer electrolyte membrane fuel cells (PEMFCs). Described herein is a Pt decorated carbon-free catalyst with solid-state proton conducting zirconium phosphate (ZrP) as support material for PEMFC. The invention further describes the process for obtaining said Pt decorated conducting zirconium phosphate (ZrP) as support material as proton conductor. Also, the present invention relates to an efficient proton conductor which optimizes utilization of Pt- catalyst thereby improving the performance of the PEMFC. The carbon-free system alleviates the problem of carbon-corrosion leading to detachment of Pt-nanoparticles.

### FIELD OF THE INVENTION

The present invention generally relates to the field of Proton Exchange Membrane Fuel Cell (PEMFC). Specifically, the present invention provides a carbon-free electrocatalyst for oxygen reduction reaction (ORR) in polymer electrolyte membrane fuel cells (PEMFCs). More specifically, the present invention relates to an efficient proton conductor which optimizes utilization of Pt-catalyst thereby improving the performance of the PEMFC. The present invention further describes the process for obtaining said Pt decorated conducting zirconium phosphate (ZrP) as support material and proton conductor. Also, the present invention is in the field of polymer membranes which exhibits improved catalyst utilization and thereby reduces the cost of the system.

### BACKGROUND AND PRIOR ART OF THE INVENTION

Proton-exchange membrane fuel cells (PEMFCs) are the cleanest energy source that can be used for a variety of applications such as transportation, residential electricity supply, etc. The PEMFCs were invented in the early 1960s by Willard Thomas Grubb and Leonard Niedrach of General Electric. Initially, sulfonated polystyrene membranes were used for electrolytes, but they were replaced in 1966 by Nafion ionomer, which proved to be superior in performance and durability to sulfonated polystyrene. Since then, PEMFCs have emerged as promising non-conventional energy devices, among various power sources.

PEMFCs are categorized into two categories, firstly, High Temperature-Proton Exchange Membrane Fuel Cell (HT-PEMFC) operating in the temperature range of 150-180° C. and secondly, Low Temperature-Proton Exchange Membrane Fuel Cells (LT-PEMFCs) working in the range of 60-80° C. HT-PEMFCs have various advantages over the LT-PEMFCs, such as high CO tolerance, easy water management, and HT-PEMFCs do not require humidified conditions to work efficiently.

In HT-PEMFCs, phosphoric acid-based poly [2,2′-(m-phenylene)-5,5′-benzimidazole (PBI) membrane is the most successful membrane system, wherein phosphoric acid groups in the membrane acts as the proton conductor and assist in the mechanics of triple-phase boundary. These have been-used as ion exchange membranes in PEM fuel cells and are described in U.S. Pat. Nos. 5,716,727 and 6,099,988. These membranes permit PEM fuel cells to operate at higher temperatures above 130° C., and exhibit lower osmotic expansion than Nafion®. However, insufficient concentration of phosphoric acid in the catalyst layer can seriously deteriorate the fuel cell performance caused by inadequate formation of the triple-phase boundary. Moreover, excess amount of phosphoric acid in the catalyst layer can encapsulate Pt-nanoparticles, thereby blocking active centres and hindering reactant access to active sites.

Further, uneven distribution of PTFE (the commonly used binder in the HT-PEMFC) can also cause non-uniform distribution of the phosphoric acid in the catalyst layer, which again adversely affects the performance of the HT-PEMFCs.

To address the aforementioned challenges, researchers have adopted different strategies; for instance, metal oxides such as SiO₂, TiO₂, ZrO₂—TiO₂ etc., have been added to the PBI membranes. Membranes modified with metal oxides such SiO₂ exhibit a proton conductivity of 0.038 S cm⁻¹ while non-composite PBI membrane has a proton conductivity of 0.01523 S/cm. Composite membranes with 2% TiO₂ exhibited the maximum power density of 438 mW cm⁻²compared to the standard fuel cell exhibiting a power density of 344 mW cm⁻². This increase in power density explains the capability of the TiO₂ to absorb the acid and water at high temperatures. Similarly, SiO₂ has been incorporated into the PBI membrane to show a similar effect as the TiO₂. The composite membrane of SiO₂ with PBI shows the power density of 0.250 mW cm⁻² compared to non-composite membrane exhibiting 0.185 mW cm⁻² at 165° C. Though metal oxides help in water and acid retention capability, they do not possess intrinsic solid-state proton conductivity.

Further, apart from inadequate triple-phase boundary formation in PEMFCs, the carbon corrosion is one of the main issues associated with performance degradation in PEMFCs. In the HT-PEMFC, carbon-corrosion is much more severe than the LT-PEMFC owing to the high operating temperature from 150° C. to 180° C. During the start-up of a fuel cell, electrodes experience significant polarization causing very high cathode potential up to 1.5 to 2.0 V. Further, at the anode catalyst sites because of the fuel starvation, necessary electron and proton are provided by the oxidation of the carbon. Carbon-corrosion leads to Pt-nanoparticles detachment from the carbon surface, porosity loss of the electrode, and increase in hydrophilicity of the carbon. Various metal oxides, highly graphitized carbon, support less Pt nanostructure has been explored to tackle this issue.

Therefore, it appears that there is still a need to develop more efficient proton exchange membranes, which can overcome the problems faced by proton exchange membranes currently available in the market.

### OBJECTS OF THE INVENTION

The main object of the present invention is to provide a carbon-free electrocatalyst for oxygen reduction reaction (ORR) in polymer electrolyte membrane fuel cells (PEMFCs).

Another object of the present invention is to provide a process for the synthesis of carbon-free electrocatalyst for oxygen reduction reaction (ORR) in polymer electrolyte membrane fuel cells (PEMFCs).

Another object of the present invention is to provide an efficient proton conductor which optimizes utilization of Pt-catalyst thereby improving the performance of the PEMFC.

Yet another object of the invention is to provide a carbon-free system which alleviates the problem of carbon-corrosion leading to detachment of Pt-nanoparticles.

Still another object of the invention is to provide a Proton Exchange Membrane Fuel Cell comprising said carbon-free electrocatalyst.

### SUMMARY OF THE INVENTION

In view of the above objects, the present invention provides a carbon-free electrocatalyst for oxygen reduction reaction (ORR) in polymer electrolyte membrane fuel cells (PEMFCs).

In general aspect, the present invention provides an electrocatalyst for oxygen reduction reaction (ORR) in polymer electrolyte membrane fuel cells (PEMFCs). The electrocatalysts are created by dispersing Pt nanoparticles on solid-state proton conductor zirconium phosphate (ZrP) nanoplates as support showing improved fuel cell performance.

In one aspect, the present invention relates to an electrocatalyst for PEM fuel cell, comprising:
a) platinum (Pt) nanoparticles, and
b) zirconium phosphate (ZrP) as a support and as a solid-state proton conductor;
wherein, said Pt nanoparticles are dispersed onto said zirconium phosphate (ZrP) nanoplates.

In another aspect, Pt-nanoparticles are dispersed on the edges of the ZrP-nanoplates (Pt/ZrP).

In another aspect, the Pt-nanoparticles are dispersed on the overall surface of the ZrP-nanoplates (ZrP@Pt).

In another aspect, the platinum (Pt) is present in the range of 35 to 45 wt. % and zirconium phosphate (ZrP) is present in the range of 65 to 55 wt. % of total composition of the electrocatalysts.

In yet another aspect, the Zirconium (Zr) is present in the range of 31 to 35 wt. % of total wt. % of zirconium phosphate (ZrP).

In yet another aspect, the average size of the Pt nanoparticles is in the range of 2.0-2.5 nm.

In yet another aspect, average diameter of ZrP nanoplates is in the range of 300 to 800 nm.

In yet another aspect, the edge length of the ZrP nanoplates is in the range of 35 nm to 50 nm.

In yet another aspect, the proton conductivity of ZrP nanoplates is in the range of 0.26×10−4 S cm⁻¹ to 0.50×10−4 S cm⁻¹ at temperature in the range of 40 to 70° C. with an activation energy (Ea) of 0.19 eV.

The solid-state proton conductor optimizes utilization of Platinum (Pt).

Further, in the ZrP nanoplates, the elemental Zr is present in the range of 31 to 35 wt %.

The Pt nanoparticles are in the range of 2.0-2.5 nm in said electrocatalysts.

In an aspect, the present invention relates to a solid-state proton conductor incorporated with Zirconium Phosphate as nanoplates.

In second aspect, the present invention relates to a process for the preparation of said electrocatalyst, comprising the steps of:
a) adding and autoclaving a mixture of zirconium oxynitrate in phosphoric acid at temperature in the range of 180 to 220° C. for time period of 3-5 hours;
b) heating and solubilizing the mixture of step (a) for 3-9 minutes followed by centrifuging the solution at speed in the range of 6000 to 9000 rpm to obtain a cake;
c) washing the cake of step (b) with a deionized water followed by drying to obtain zirconium phosphate (ZrP);
d) dispersing the ZrP of step (c) in a water under sonication followed by addition of Pt salt;
e) adding a solvent into the suspension of step (d) followed by sonication;
f) adding a urea into the suspension of step (e) followed by heating and stirring to obtain a catalyst suspension; and
g) filtering out the suspension as obtained in step (f) followed by drying the residue to obtain the desired electrocatalyst.

In another aspect, the the heating of step (b) is done at a temperature in a range of 180 to 230° C. for time period of 3 to 5 hours.

In yet another aspect, the heating of step (f) is done at a temperature range of 35 to 120° C. for time period of 1 to 24 hours.

In yet another aspect, the drying of step (c) is done at temperature in a range of 50 to 70° C. for time period of 10 to 15 hours;

In yet another aspect, the drying of step (g) is done at a temperature in a range of 60 to 80° C. for time period of 10 to 15 hours.

In yet another aspect, the sonication in step (d) is done for a time period of 5 to 10 minutes.

In yet another aspect, the sonication in step (e) is done for a time period of 30 to 45 minutes.

In yet another aspect, the Pt salt used in step (d) is selected from the group consisting of chloroplatinic acid hexahydrate (H₂PtCl₆·6H₂O), sodium tetrachloroplatinate (II) hydrate (Na₂PtCl₄·xH₂O), potassium tetrachloroplatinate (II) (K₂PtCl₄) and platinum tetrachloride (PtCl₄).

In yet another aspect, the solvent used in step (e) is selected from the group consisting of ethylene glycol, propylene glycol and diethylene glycol.

In an aspect, the present invention provides a process for manufacturing the Pt-decorated ZrP-nanoplates, comprising a synthesis of ZrP nanoplates followed by decoration of Pt-nanoparticles over the ZrP-nanoplates.

In an alternative aspect, the present invention provides a method of preparing the proton conductor incorporated with Zirconium Phosphate, comprising the steps of:
a) adding Zirconium Oxynitrate in 6.0 M H₃PO₄ in a autoclave to form a mixture;
b) solubilizing the mixture of step (a) for 5 minutes and keeping at 200° C. for 4 hours;
c) centrifuging the solution of step (b) at 8000 rpm, and
d) washing the cake of step (c) with deionized water until the pH of the supernatant was equal to the pH of the DI water. The obtained product was dried for 12 hours at 60° C.

In another alternative aspect, the present invention provides a method for the synthesis of electrocatalyst for oxygen reduction reaction (ORR) comprising the steps of:
a. dispersing ZrP in water by sonication;
b. adding required amount of Pt salt to the solution of step (a);
c. adding solvent into the suspension of step (b) and again sonicating the said suspension;
d. stirring the suspension of step (c) for 24 hours at 35° C. and then heated at 120° C. for 1 hour, and
e. filtering the solid obtained in step (d) and drying said solid for 12 hours.

The sonication in step (a) is done for a time period of 5-10 minutes; wherein the sonication in step (c) is done for a time period of 30-45 minutes; and wherein the sonication is done using ultrasonic bath sonicator.

The Pt salt used in step (b) is selected from the group consisting of Chloroplatinic acid hexahydrate (H₂PtCl₆·6H₂O), Sodium tetrachloroplatinate (II) hydrate (Na₂PtCl₄·xH₂O), Potassium tetrachloroplatinate (II) (K₂PtCl₄) and Platinum tetrachloride (PtCl₄).

The Pt salt used in step (b) is Chloroplatinic acid hexahydrate (H₂PtCl₆·6H₂O).

In third aspect, the present invention relates to a PEM fuel cell, comprising:
a) the electrocatalyst as disclosed herein, which is coated onto a gas diffusion layer (GDL),
b) a cathode,
c) an anode, and
d) a solid state electrolyte membrane placed between the cathode and anode.

In another aspect, the cathode is a material selected from platinum-carbon (Pt/C), platinum-trioxide (Pt/WO3), platinum-nickel-carbon (Pt3Ni/C), platinum-cobalt-carbon (Pt3Co/C), and Pt-black.

In yet another aspect, the anode is a material selected from Pt/C, Pt-black, platinum-ruthenium-carbon (PtRu/C), and Pt/WO3.

In yet another aspect, the solid state electrolyte membrane is nafion.

The solid-state proton conductor is a non-carbonaceous electrocatalyst which alleviates the issue of carbon corrosion.

In an aspect, the present invention provides a non-carbonaceous electrocatalyst which helps in formation of an efficient triple-phase boundary.

### BRIEF DESCRIPTION OF THE DRAWINGS:

FIG. 1A illustrates the FE-SEM images of the synthesized ZrP nanoplates; FIG. 1B illustrates the FE-SEM images of the synthesized ZrP@Pt; and FIG. 1C illustrates the FE-SEM images of the synthesized Pt/ZrP. In the case of ZrP@Pt, the Pt nanoparticles are found to be closely distributed and completely covering the ZrP nanoplates, whereas in Pt/ZrP, the Pt nanoparticles have selectively restricted dispersion along the edges of the support.

FIG. 2 illustrates the XRD pattern for the ZrP, ZrP@Pt and Pt/ZrP.

FIG. 3 illustrates TEM images of the Pt decorated at the edges of the solid-state proton conductor under various magnifications. The TEM images recorded at different magnifications: a) to c) Pt/ZrP displaying the Pt decoration selectively along the edges of the ZrP nanoplates, and d) to f) ZrP@Pt having the Pt nanoparticles decorated over the entire surface of the nanoplates of ZrP.

FIG. 4 illustrates the XPS profile of various systems: The XPS profiles of ZrP, Pt/ZrP, and ZrP@Pt: a) the comparative survey spectra of the samples; b-e) the XPS core spectra of Zr 3d b), O 1s c), P 2p d), and Pt 4f e).

FIG. 5 illustrates electrochemical evaluation for ORR characterization: a) The cyclic voltammograms (CVs) recorded for Pt/ZrP, ZrP@Pt, and Pt/C at a scan rate of 50 mV s⁻¹ in N2 and O2 saturated environments in 0.1 m HClO4 electrolyte; b) a comparison of the LSV profiles for the samples recorded with a scanning rate of 10 mV s⁻¹ and the working electrode rotational frequency of 1600 rpm; c) construction of Tafel plots for Pt/ZrP, ZrP@Pt, and Pt/C; d,e) the Koutecky-Levich (K-L) plots recorded at various potentials for ZrP@Pt and Pt/ZrP; and f) estimation of the H2O2 (%) formed and the number of electrons (n) involved in the ORR process as calculated using the RRDE technique.

FIG. 6 illustrates a comparative LSV profile recorded at a scan rate of 10 mV s⁻¹ before ADT and after completing the 3000 cycles of ADT.

FIG. 7 illustrates comparative CV profiles recorded for ZrP@Pt before ADT and after completing the 3000 cycles of ADT recorded at a scan rate of 50 mV s⁻¹.

FIG. 8 illustrates comparative LSV profiles of Pt/ZrP recorded at a scan rate of 10 mV s⁻¹ before ADT and after completing the 5000 cycles of ADT.

FIG. 9 illustrates comparative CV profiles of Pt/ZrP recorded at a scan rate of 10 mV s⁻¹ before ADT and after completing the 3000 cycles of ADT.

FIG. 10 illustrates comparative LSV profiles of Pt/C recorded at a scan rate of 10 mV s⁻¹ before ADT and after completing the 3000 cycles of ADT.

FIG. 11 illustrates comparative CV profiles for Pt/C before ADT and after completing the 3000 cycles of ADT recorded at a scan rate of 50 mV s⁻¹.

FIG. 12 illustrates Pt/ZrP before the 3000 start-stop cycles.

FIG. 13 illustrates the reactions scheme for the process for manufacturing the solid-state proton conductor of the invention. Two types of Pt dispersed catalysts are derived, where, in one case, the Pt nanoparticles are dispersed only along the outer edges of the ZrP nanoplates (Pt/ZrP) and, in the other case, the ZrP nanoplates are completely encapsulated by a coverage of closely dispersed Pt nanoparticles throughout their surface (ZrP@Pt).

FIG. 14 shows the I-V polarization plots recorded in the single-cell mode of PEMFC using the membrane electrode assemblies consisting of ZrP@Pt, Pt/ZrP, and Pt/C as the electrocatalysts under H₂/O₂ feed condition.

FIG. 15 shows the PEM fuel cell consisting of ZrP@Pt, Pt/ZrP, and Pt/C as the electrocatalysts under H₂/O₂ feed condition. The electrode is prepared by applying the slurry to a gas diffusion layer (GDL).

### DETAILED DESCRIPTION OF THE INVENTION:

The use of the word “a” or “an” when used in conjunction with the term “comprising” in the claims and/or the specification may not only mean “one”, but also encompasses the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

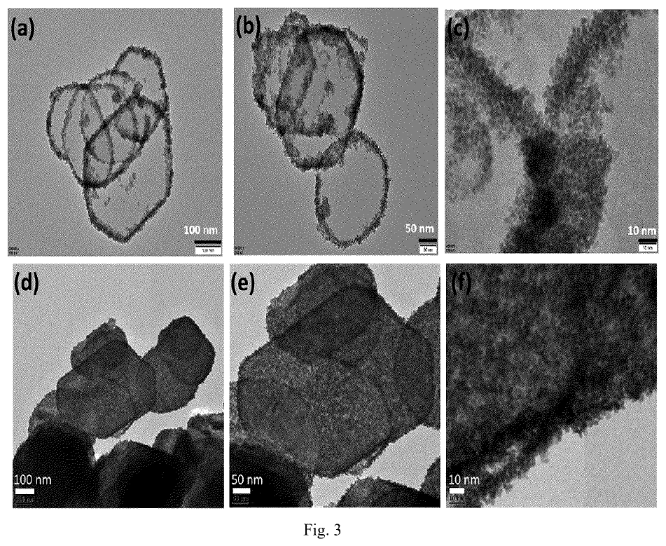

The term “Pt/ZrP” used herein means that the Pt-nanoparticles are dispersed on the edges of the ZrP-nanoplates (refer FIG. 3).

The term “ZrP@Pt” used herein means that the Pt-nanoparticles are dispersed on the overall surface of the ZrP-nanoplates (refer FIG. 3).

Described herein is a solid-state proton conductor made from Zirconium hydrogen phosphate/zirconium phosphate (ZrP) as non-carbonaceous support in intimate contact with the Platinum nanoparticles (Pt-nanoparticles). Phosphate groups in ZrP possess acidic functionality; the intimate contact between the Pt-nanoparticles and phosphate group of the ZrP helps in formation of an efficient triple-phase boundary. In addition, surface phosphate functionality modulates the activity and the stability of the Pt-nanoparticles for the oxygen reduction reaction (ORR). Finally, ZrP as non-carbonaceous support alleviates the issues associated with carbon corrosion.

Commercially available platinum-supported carbon (Pt/C) catalysts are the most widely used oxygen reduction reaction (ORR) electrode catalysts in polymer electrolyte membrane fuel cells (PEMFCs). However, inadequate triple-phase boundary formation and carbon oxidation in Pt/C during PEMFC operation shortens its lifetime and efficiency. Therefore, the current invention provides a solid-state, non-carbonaceous proton conductor made from ZrP.

Accordingly, in an embodiment, the invention provides a Platinum-decorated carbon-free catalyst with solid-state proton conducting zirconium phosphate (ZrP) as support material for Oxygen Reduction Reaction in Polymer Electrolyte Membrane Fuel Cell Applications.

Decorating Pt over the Zirconium hydrogen phosphate (ZrP) substrate leads to better Pt utilization strategy thereby improving the performance of the fuel cell.

Pt is decorated over ZrP using the polyol method. Acidic functionality present on the ZrP helps in maintaining the triple-phase boundary due to the presence of the acidic functionality and leads to the effective utilization of the Platinum.

In an embodiment, the Pt-decorated ZrP are manufactured by sonicating H₂PtCl₆·6H₂O with ZrP nanoplates. The process involves initial production of ZrP nanoplates followed by sonication of said nanoplates with H₂PtCl₆·6H₂O.

In one more embodiment, the invention provides a process for manufacturing the Pt-decorated ZrP-nanoplates of the invention. The process comprises two parts, first part being synthesis of ZrP nanoplates and second part being decoration of Pt-nanoparticles over the thus synthesized ZrP-nanoplates.

Accordingly, ZrP-nanoplates are synthesized by adding Zirconium Oxynitrate in 6M H₃PO₄ and autoclave the same. The mixture was solubilized for 5 minutes and kept at 200° C. for 4hrs. The product was obtained by centrifugation at 8000 rpm for 5 minutes and washed with DI water, until the pH of the supernatant was equal to the pH of the DI water. The obtained product was dried for 12 hours.

In accordance with the above embodiment, the Pt-nanoparticles can be decorated on the edges of the ZrP-nanoplates (Pt/ZrP) or on the surface of the ZrP-nanoplates (ZrP@Pt).

To obtain ZrP-nanoplates with Pt-nanoparticles decorated on the edge of said ZrP-nanoplates (Pt/ZrP), ZrP is dispersed in water by sonication, followed by addition of required amount of H₂PtCl₆·6H₂O. After sonication, ethylene glycol was added into the above suspension and again sonicated. After sonication, the suspension was stirred for 24 hours and then heated for 1 hour. Then urea was added into the above solution. The product was obtained by filtration and washed with water and ethanol. The obtained product was kept for drying for 12 hours.

Alternatively, ZrP-nanoplates with Pt-nanoparticles decorated on the surface of said ZrP-nanoplates (ZrP@Pt) is obtained by dispersing ZrP in water by sonication, followed by addition of required amount of H₂PtCl₆·6H₂O. After sonication, ethylene glycol was added into the above suspension and again sonicated. Then, urea was added into the above suspension and the suspension was stirred for 10-12 hours and then heated for 1 hour. The product was obtained by filtration and washed with water and ethanol. The obtained product was kept for drying for 12 hours.

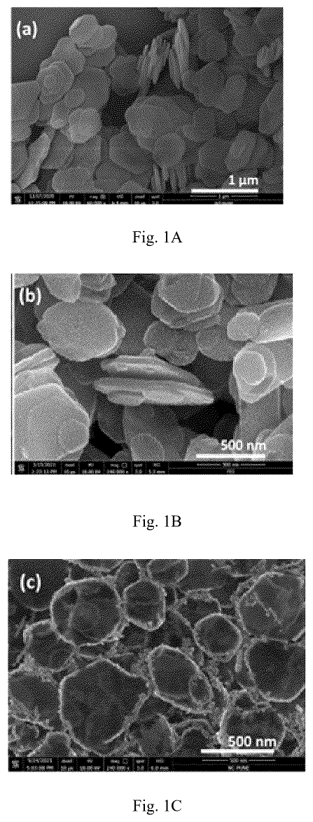

The hence formed ZrP-nanoplates were physically characterized using Field emission scanning electron microscopy (FEM-SE). The said micrographs are illustrated in FIG. 1A-1C. FE-SEM images clearly show the majority of the synthesized product exhibits hexagonal morphology (FIG. 1A). The average diameter of the synthesized ZrP plates was around ˜400 nm, while edge length varies from 35 nm to 50 nm. FIG. 1B shows the Pt decorated over the surface of the ZrP nanoplates (ZrP@Pt). It is clear from the rough patches and dotted pattern that the Pt nanoparticles are uniformly distributed over the surface of ZrP in ZrP@Pt. Similarly, FE-SEM analysis shows the Pt located at the edges of ZrP in Pt/ZrP (FIG. 1C).

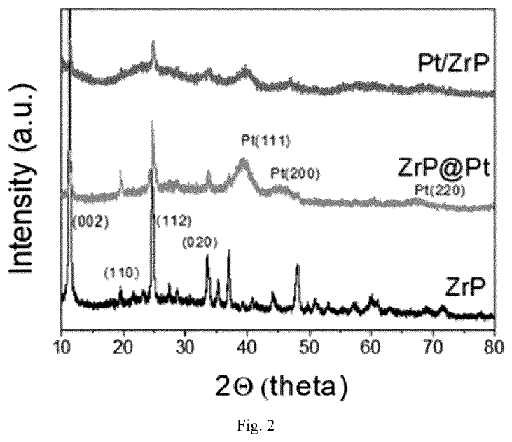

The Pt decorated ZrP-nanoplates were further subjected to XRD Analysis. XRD analysis of ZrP, ZrP@Pt and Pt/ZrP is shown in FIG. 2; the appearance of the peaks at 2Θ value of 11.27°,19.48°, 24.61°, and 33.50° corresponds to the (002), (110), (112) and (020) planes of the ZrP which confirms the alpha-phase of ZrP. In case of ZrP@Pt, diffraction peaks at 11.27°, 19.52°,24.69°, and 33.61° corresponds to the (002), (110), (112) and (020) planes of ZrP, whereas the peaks at 39.40° and 46.6° represents (111) and (200) planes of Pt which shows the Pt nanoparticles in the metallic state. Further, decrease in the peak intensities of ZrP@Pt with respect to ZrP can be attributed to the surface coverage of ZrP by Pt nanoparticles (FIG. 2). While presence of broad peak in XRD pattern of Pt/ZrP reveals the amorphous nature of the ZrP, whereas appearance of diffraction peak at 20 value of 39.8°, and 46.94° again represents Pt (111) and Pt (200) plane.

The Pt decorated ZrP-nanoplates were further subjected to TEM Analysis. TEM analysis of the ZrP nanoplates shows the smooth surface and hexagonal morphology. Further, Pt nanoparticles morphology, their distribution on the surface of the ZrP was characterized by the TEM analysis which is shown in FIG. 3(a-c). TEM images in FIG. 3 clearly show the Pt nanoparticles exclusively located at the edges of the ZrP (Pt/ZrP). Contrastingly, Pt in TEM images shown in FIG. 3(d-f) clearly shows Pt nanoparticles located over the surface of ZrP (ZrP@Pt), which conforms with peak intensity of XRD analysis. Pt nanoparticles decorated either at edges or over the surface of ZrP exhibit interconnectivity generating inter-grain boundaries that enhance conductivity and charge transfer, thereby improving electro-catalytic properties of Pt nanoparticles. Average size of Pt nanoparticles is around 2.0-2.5 nm.

Further, d-spacing was found to be around 0.216 nm, which corresponds to Pt(111), further confirming the metallic nature of the Pt nanoparticles. Furthermore, in the case of Pt/ZrP, it has been observed that increasing the weight percentage of Pt to 80 wt. % leads Pt nanoparticles to occupy only the edges of ZrP. The nucleation of the Pt nanoparticles that occurs alongside the edge is due to the amorphous nature of the ZrP, as revealed by the XRD analysis. Pt species does not coordinate with the hydroxyl group on the ZrP surface, therefore nucleation happens only along the edges.

The crystalline nature of ZrP in ZrP@Pt might be responsible for the Pt nanoparticles anchoring along the surface. In crystalline ZrP, Pt species coordinates with the hydroxyl group-oriented along the surface, and nucleation happens on the surface of ZrP. The composition and distribution of elements in Pt/ZrP and ZrP@Pt was characterized by the energy-dispersive X-ray spectroscopy (EDX)

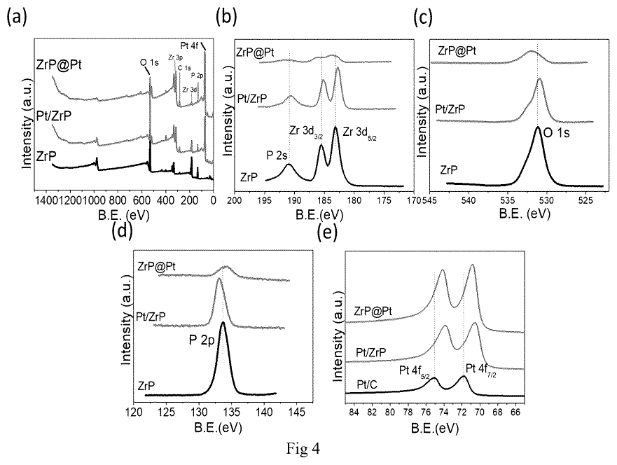

The Pt-decorated ZrP-nanoplates were further subjected to XPS analysis. The XPS survey spectrum is illustrated in FIG. 4. The XPS survey spectrum of ZrP, ZrP@Pt, and Pt/ZrP given in FIG. 4a, confirms the presence of Zr, P, O, and Pt in the respective catalysts. Core level XPS spectra of the Zr 3d show the two separate regions viz, Zr 3d_{3/2} and Zr 3d_{5/2} due to spin-orbital coupling. Binding energies values of Zr 3d_{3/2} and Zr 3d_{5/2} in unsupported ZrP are 185.5 eV and 183.2 eV, respectively. Whereas BEs of Zr 3d_{3/2} in ZrP@Pt and Pt/ZrP is 186.15 eV and 185.19 respectively, and for Zr3d_{5/2} BEs are 183.85 eV and 182.79 eV, respectively. BEs for O 1s in ZrP, ZrP@Pt and Pt/ZrP appears at 531.1 eV, 532.05 eV and 530.89 eV respectively (FIG. 4c). Higher shift in the binding energy for O 1s in ZrP@Pt further validates the strong Pt—O interaction. The BE value for P 2p appears at 133.7 eV and 133.95 eV for ZrP and ZrP@Pt respectively (FIG. 4d). A higher shift in the BE value for P 2p in ZrP@Pt clearly shows the strong Pt-P interaction. In contrast, the BE for Pt/ZrP appears at 133.09. The difference in the binding energy of the Zr 4f, O 1s, and P 2p in the ZrP@Pt and Pt/ZrP can be explained in terms of the Pt nanoparticles interaction with the ZrP surface.

Similar to the Zr 3d, Pt 4f core spectra exhibit two distinct peaks, viz. Pt 4f_{5/2} and Pt 4f_{7/2} due to the spin-orbital coupling. Note that the 4f peaks in the case of ZrP@Pt have been shifted to low binding energies (4f_{5/2} at 74.15 eV and 4f_{7/2} at 70.85 eV), compared to the Pt peaks in Pt/C (4f_{5/2} at 75.09 eV and 4f_{7/2} at 71.79 eV). Similarly, in the case of Pt/ZrP BEs for Pt 4f_{5/2} and Pt 4f_{7/2} appears at 73.89 eV and 70.49 eV, respectively (FIG. 4e). Lowering of the BEs of Pt in the case of the ZrP@Pt and Pt/ZrP compared to the Pt/C further confirms the substrate and Pt nanoparticle strong metal-support interaction (SMSI). It is evident from Pt 4f BEs values that interaction of Pt with ZrP in Pt/ZrP is much stronger than the ZrP@Pt. The change in the BEs value of Pt 4f in Pt/ZrP and ZrP@Pt might be due to the different coordinating environment of the Pt nanoparticles. The charge transfer between ZrP and Pt shifts the d-band centre of Pt 4f to the lower energy. This led to variation in adsorption strength of oxygen/oxygen intermediates and can lead to improved catalytic activity for ORR.

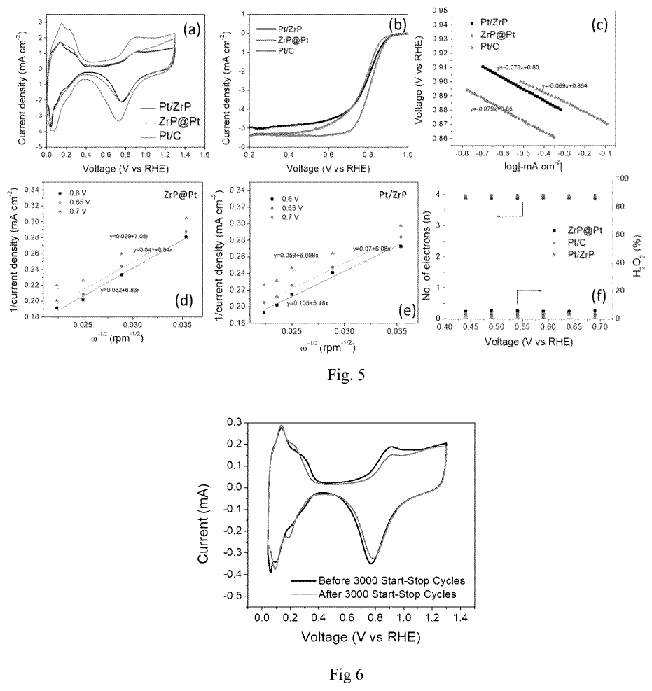

The Pt-decorated ZrP nanoplates were further subjected to electrochemical characterization. Electrochemical analysis of the catalysts and their oxygen reduction reaction (ORR) activity was carried out using cyclic voltammetry (CV), rotating disk electrode (RDE), and rotating ring disk electrode (RRDE) in 0.1 M HClO₄ CV profile of ZrP@Pt and Pt/ZrP recorded in nitrogen saturated electrolyte is shown in FIG. 5a. CV profile shows the typical characteristics of the Pt in HClO₄ as the electrolyte. Redox peaks in the potential region of 0 to 0.3 V are ascribed to the under-potential H absorption and desorption. Also, CV in an N2 saturated environment, H-desorption at the potential of 0.13 V and 0.22 V can be attributed to the (110) and (100) step sites of the Pt, respectively. Hydrogen desorption region in the CV was used for calculating the electrochemical surface area (ECSA); measured ECSA values are 33 m² g_{Pt} ZrP@Pt, 32 m² g_{Pt} for Pt/ZrP and 50 m² g^{-pt} for Pt/C (FIG. 5a) The variation in the ECSA can be explained by the extended interconnectivity of the Pt nanoparticles along the edges and over the surface of ZrP leading to the decrement in the ECSA compare to the Pt/C. Linear sweep voltammetry (LSV) was recorded for measuring the intrinsic ORR activity of the various catalyst; shown in FIG. 5b onset and half-wave potentials measured are 0.97 V and 0.81 V for Pt/C, 0.96 and 0.77 V for 40% ZrP@Pt, and 0.97 V and 0.80 V for 40% Pt/ZrP. The high onset and half-wave potential of Pt/ZrP compared to the ZrP@Pt can be attributed to strong electronic interaction between ZrP and Pt. The synthesized systems exhibit the similar activity as that of the state-of-the-art Pt/C system. However, these systems possess various advantages over the Pt/C such as corrosion resistance (rampant in carbon support), intimate contact between proton-conducting phosphate group and Pt nanoparticles may lead to effective utilization of the Pt in PEMFC fuel cell application, etc. Tafel plots (FIG. 5c) gives further insight into the kinetics of ORR reaction catalyzed by the synthesized catalysts. Tafel slopes measured for Pt/ZrP, ZrP@Pt and Pt/C are 78 mV dec⁻¹, 79 mV dec⁻¹ and 69 mV dec⁻¹ respectively (FIG. 5c). The Tafel values show almost the similar value showing the equivalent kinetic. We also calculated Koutechey-Levich (K-L) plots to gain information about the number of electron transfer and kinetics of the ORR on the prepared catalysts.

The number of electron transfer is calculated using K-L equation;

$$\frac{1}{j} = \frac{1}{{j}_{k}} + \frac{1}{B {ω}^{0.5}} \qquad ( 1 )$$

here B=0.2nFD_{O2}^{2/3}v^{-1/6}Co₂, n is the number of electron transfer, F is the faraday constant (F=96500 C), A is the electrode area (A=0.196 cm²), D is the diffusion constant (D=1.9×10⁻⁵ cm² s⁻¹); v is the kinematic viscosity of the electrolyte (0.01 cm² s⁻¹), ω is the electrode rotation in rpm; Co₂ is the bulk O₂ concentration (Co₂=1.2×10⁻⁶ mol cm³). The average electron transfer was found to be similar both for Pt/ZrP and ZrP@Pt, confirming the 4 electron pathway (FIG. 5d-e). Further, the amount of H₂O₂ produced during the ORR over catalyst surface (representing parasitic 2-electron transfer reaction) was measured using rotating ring disk electrode (RRDE) analysis. The equations for H₂O₂% and No. of electron transfer are given below:

$$n = 4 {i}_{d} / ( {i}_{d} + \frac{{i}_{r}}{N} ) \qquad ( 2 )$$

$$H 2 O 2 ( \% ) = ( 200 {i}_{r} / N ) / ( \frac{{i}_{r}}{N} + {i}_{d} ) \qquad ( 3 )$$

Where i_{d} and iᵣ are the disks and the ring current from the RRDE analysis and N is the current collection efficiency. The measurements were made by keeping the ring at a potential of 1.2 V vs. RHE. A comparative plot for the ring potential and the disk potential for ZrP@Pt, Pt/ZrP and Pt/C and the amount of H₂O₂ measured was 6.8%, 2.0% and 3.8% for ZrP@Pt, Pt/ZrP and Pt/C.

Since one of the primary reasons to supplant C with ZrP is to accomplish long-term electrochemical performance and stability by avoiding the corrosion of the support material; we carried out an accelerated durability test (ADT) wherein the electro-catalysts were cycled under high over potentials between 1.0 V to 1.5 V for 3000 cycles at a scan rate of 100 mV s⁻¹under N₂-saturated electrolyte; these testing conditions accelerate corrosion of the support material The CV recorded before and after 3000 cycles of ADT (FIG. 5a-f) indicate the changes in the electrochemical properties of the catalysts. Hydrogen desorption region for Pt/C decreased by almost ˜20%, while for Pt/ZrP and ZrP@Pt, hydrogen desorption region is almost overlapping.

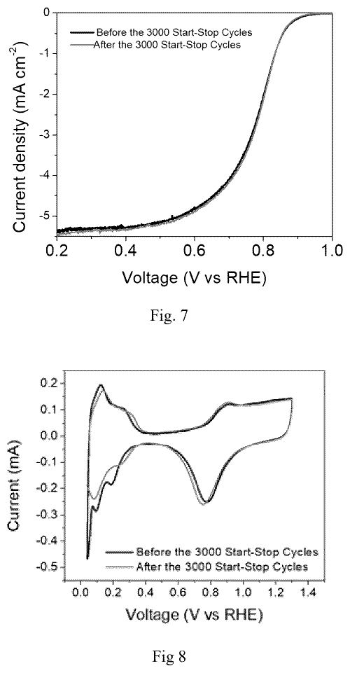

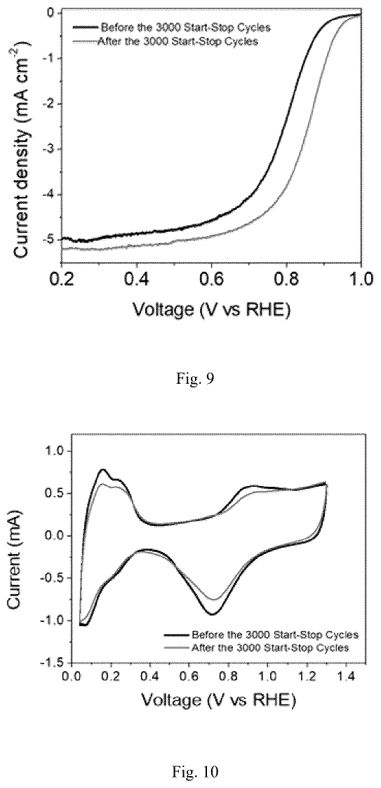

The analysis clearly established high stability of Pt-nanoparticles anchored to ZrP. To intently assess the change brought about to the ORR attributes, LSV profiles were additionally recorded before and after 3000 cycles of ADT FIGS. 6 to 11. FIGS. 6-8 show the comparative CV profiles recorded for Pt/ZrP, ZrP@Pt, and Pt/C at a scan rate of 50 mV s⁻¹ before and after completing the 3000 cycles of ADT, and FIGS. 9-11 show the comparative LSV profiles recorded for Pt/ZrP, ZrP@Pt, and Pt/C before and after completing the 3000 cycles of ADT, recorded at a scan rate of 10 mV s⁻¹. A negative shift of 10 mV in the half-wave potential (E1/2) was observed for Pt/C (FIG. 9). In contrast, for Pt/ZrP a positive shift in the E_{1/2} of 50 mV was observed, highlighting the better primary and electrochemical perseverance brought about by using ZrP as the substrate (FIGS. 6 and 8). The mass activity was calculated using the kinetic current density before and after 3000 cycles of ADT. In case of Pt/C mass activity was decreased by almost 1.3 times while in case of ZrP@Pt it was increased by 4.6 times. This kind of anomalous behaviour is also observed with Pt deposited on the thiolated carbon nanotubes. Further, FIG. 14 provides two notable features of the I-V plot traced by the Pt/ZrP-based MEA, in comparison to that based on Pt/C, that are the comparatively high overpotential incurred in the activation polarization region (i.e., the low current density region) and the better performance in the mass transfer sensitive region (i.e., the high current density region) by the homemade system.

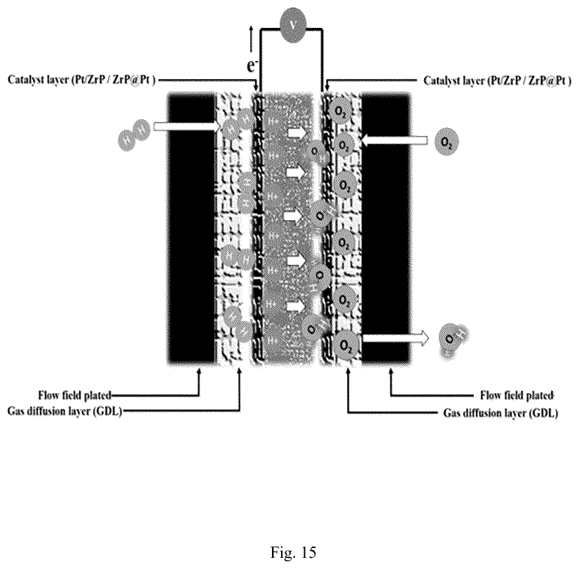

Also, FIG. 15 provides a PEM fuel cell consisting of ZrP@Pt, Pt/ZrP, and Pt/C as the electrocatalysts under H₂/O₂ feed condition. The electrocatalyst is coated over the gas diffusion layer (GDL) which is used as an electrode for hydrogen oxidation at anode and oxygen reduction at cathode. The Nafion membrane is sandwiched between the cathode and anode that is used for the proton conduction. Cathode is part of the fuel cell where oxygen reduction takes place that can be used for the metal-air batteries, direct methanol fuel cells, direct ethanol fuel cell, direct formate/formic acid fuel cells. At anode, hydrogen oxidation reactions take place. Proton exchange membrane is used for the transfer of protons from anode compartment to the cathode compartment.

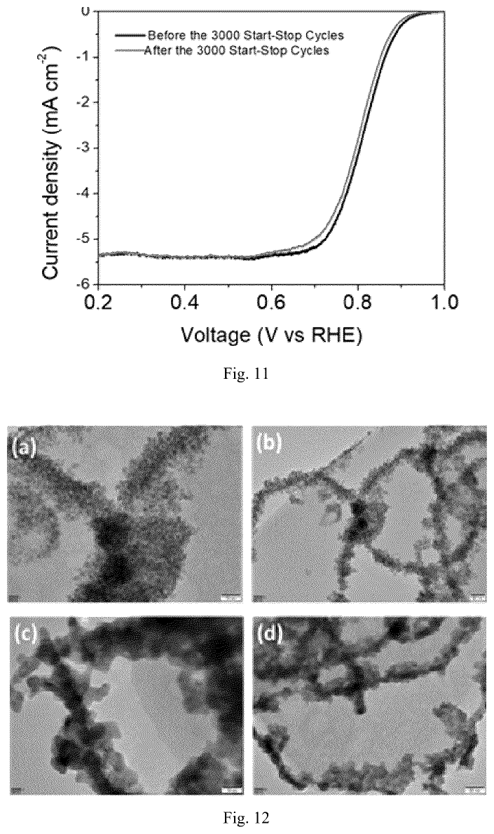

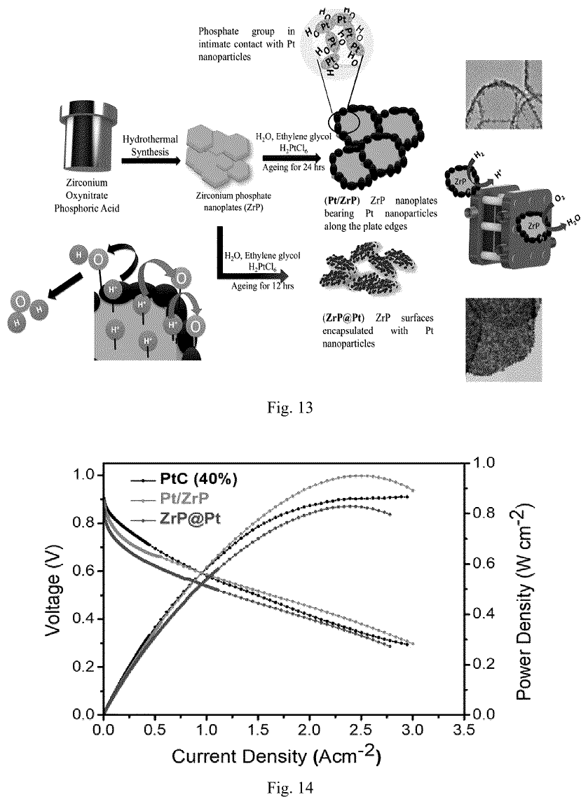

Furthermore, post-analysis of the Pt/ZrP was carried out for the increment in mass activity that was observed. TEM analysis clearly shows the interconnected Pt nanoparticles transformed into the array of connected nanowires having rough surfaces (FIG. 12). Rough surface is known to contain the higher-index facets which are known to have enhanced oxygen reduction reaction activity. This structural transformation might be due to the strong interaction between the ZrP and Pt nanoparticles which does not allow the particle to agglomerate. The strong interaction between the Pt nanoparticles and phosphate.

The EDX mapping clearly reveals the presence of the Zr, O, P, and Pt, further supporting the distinct nature of the distribution profiles of Pt in Pt/ZrP and ZrP@Pt.

The EDAX analysis indicates a Pt loading of 31 to 35 wt %, in the case of Pt/ZrP and ZrP@Pt (Tables 1 below).

TABLE 1
Pt/ZrP and ZrP@Pt catalyst having the wt. % of different elements.

| Element | Wt % | At % |
|---|---|---|
| O K | 21-26 | 61-66 |
| P K | 9-11 | 13-14 |
| Zr L | 31-36 | 13-17 |
| Pt L | 31-35 | 6-8 |

In a nutshell, a new class of carbon-free electrocatalysts for oxygen reduction reaction (ORR) has been created by decorating Pt nanoparticles on zirconium phosphate (ZrP) nanoplates, which display solid-state proton conductivity. Two distinct types of dispersion patterns of the nanoparticles of Pt (40 wt %) on ZrP nanoplates have been observed. In the first case, represented as ZrP@Pt, the Pt nanoparticles are found to be closely distributed and completely covering the ZrP nanoplates, whereas, in the second case, designated as Pt/ZrP, the Pt nanoparticles have selectively restricted dispersion along the edges of the support. The proton conductivity of ZrP nanoplates ranges from 0.26×10−4 S cm⁻¹ to 0.50×10−4 S cm⁻¹ at 40 to 70° C. in 95% humidity with an activation energy (Ea) of 0.19 eV. Both ZrP@Pt and Pt/ZrP are displaying promising ORR characteristics. However, Pt/ZrP is found to be an interesting system with respect to its ORR performance because the system shows enhancement in the performance during the course of the electrochemical potential cycling processes. This favorable activity modulation toward ORR is found to have originated from the transformation of the interconnected Pt nanoparticles along the edges of ZrP into an array of connected nanowires having rough protruded surfaces. This results in the increase of the roughness factor and exposure of the higher-index facets, thus contributing favorably toward ORR. Also, the composite catalyst shows strong evidence of charge transfer from the ZrP to the Pt nanoparticles, leading to strong metal-support interactions. The strong anchoring of the Pt with the phosphate group is possibly the reason for the observed high durability of the ZrP-based catalysts. Also, the observed more positive onset potential and E1/2 values of Pt/ZrP compared to ZrP@Pt can be attributed to strong electronic interaction between ZrP and Pt as validated through the XPS results, which can directly affect the strength of adsorption of the oxygen and oxygen intermediates. The single-cell evaluation of the MEAs based on Pt/ZrP and ZrP@Pt displayed a trend that conforms to the intrinsic ORR performance of the systems. The performance of the MEA based on Pt/ZrP is found to be superior to that of the one based on Pt/C at the operating potentials above 0.60 V. The controlled interplay of the advantageous factors such as the activation induced morphological transformation of the dispersed state of the Pt nanoparticles, intrinsic proton conductivity of the ZrP substrate, better exposure and accessibility of the Pt nanoparticles and overall improved mass transfer characteristics of the catalyst layer are expected to be favoring the cell based on the homemade catalyst.

### EXAMPLES

Following examples are given by way of illustration and therefore should not be construed to limit the scope of the invention.

Example 1: Synthesis of ZrP: For the synthesis of the zirconium phosphate (ZrP) nanoplates, in a typical synthesis route of ZrP, 1.4 g of zirconium oxynitrate was added into the 20 mL of 6.0 m H₃PO₄ in a 25 mL autoclave. The mixture was subsequently solubilized for 5 minutes and was kept at 200° C. for 4 hours. The product was obtained by centrifugation at 8000 rpm for 5 minutes and was washed with DI water until the pH of the supernatant becomes equal to the pH of the DI water. The obtained product was dried for 12 hours at 60° C.

Example 2: Synthesis of ZrP Nanoplates encapsulated with Pt Nanoparticles (ZrP@Pt): 60 mg of the ZrP was first dispersed in water by sonication; followed by this, the required amount of H₂PtCl₆·6H₂O was added based on a targeted Pt loading of 40 wt %. After sonication for 5 minutes, ethylene glycol was added into the above suspension and again the mixture was sonicated for 30 minutes. Followed by the addition of urea into the above mixture, the suspension was stirred for 10-12 hours at 35° C. and thereafter heated at 120° C. for 1 hour. The wet cake obtained after filtration was washed sequentially with water and ethanol. The obtained product was kept for drying at 70° C. for 10-12 hours. The product thus obtained is designated as ZrP@Pt since the Pt nanoparticles are found to be covering the entire surface of the ZrP nanoplates.

Example 3: Synthesis of ZrP Nanoflates bearing Pt Nanoparticles along the edges (Pt/ZrP): The synthesis procedure involved in this case was similar to that of ZrP@Pt except for the ageing of the ZrP which was carried out by stirring the suspension for 24 hours after adding ethylene glycol, compared to 12 hours as performed in the previous case. The product thus obtained is designated as Pt/ZrP since the Pt nanoparticles are found to be dispersed selectively along the edges of the nanoplates of ZrP.

Example 4: Proton Conductivity Measurement: Proton conductivity of the material was measured using electrochemical impedance spectroscopy (EIS) in humidified conditions. For the measurements, a homemade setup was used, where the pellets of the material (13 mm in diameter) were placed between two stainless steel electrodes and the set-up was moved inside a humidity-controlled temperature chamber (SH-241, ESPEC Co. Ltd., Japan), which was also connected to an electrochemical workstation (VMP-3) from BioLogic. The sample was left inside the humidity chamber for at least 1 h for equilibration before the measurements. For the EIS measurements, an input AC voltage of amplitude of 10 mV was applied to the pellet under OCV conditions and the frequency was scanned from 1 MHz and 0.1 Hz. In each case, the proton conductivity was calculated using the Pouillet's equation, σ=L/R×A, where σ is the conductivity (S cm⁻¹), L is the thickness (in cm) and A is the electrode area (in cm⁻²).

$$L = 0.1 \; 08 cm ; r = 0.65 cm ; R = 1643.68 Ω \\ σ = \frac{0.1080}{3.14 \times 0.65 \times 0.65 \times 1 643.68} = 0.495279 \times 1 {0}^{- 4} S {cm}^{- 1}$$

Example 5: Single-Cell Testing of PEMFC: In the present study, DuPont Nafion HP membranes were used as the proton conducting membrane. The electrode slurry for both the anode and cathode electrodes was prepared by mixing Pt/ZrP, functionalized carbon and Nafion-20 wt % (DuPont, USA) in isopropanol using bath sonication for 2 hours. In the case of Pt/ZrP, the ionomer to catalyst ratio was maintained at 0.30. The electrode was prepared by applying the slurry to a gas diffusion layer (GDL) (SGL Carbon Company) with an anode and cathode Pt loading of 0.50 mg cm⁻². The electrodes (3.5 cm×3.5 cm in size) were vacuum dried at 130° C. and hot pressed at 130° C. against the Nafion HP membrane for 3 min to prepare the MEA. Subsequently, the MEA was fixed in a standard test fixture (Fuel Cell Technologies, Inc., USA) by applying a torque of 3 Nm. Hydrogen was used as the fuel and oxygen/air gas were used as the oxidant. The testing was performed at 70° C. with a relative humidity of 60%.

### ADVANTAGES OF THE INVENTION

Efficient triple-phase boundary formed;
Pt consumption reduced, effectively reducing the cost of the cell;
Surface phosphate functionality modulates the activity and the stability of the Pt-nanoparticles for the oxygen reduction reaction (ORR); and
Use of ZrP as non-carbonaceous support alleviates the issues associated with carbon corrosion.

We claim:

1. An electrocatalyst for proton exchange membrane (PEM) fuel cell, comprising:
a) platinum (Pt) nanoparticles, and
b) zirconium phosphate (ZrP) nanoplate(s) as a support and a solid-state proton conductor;
wherein the Pt nanoparticles are dispersed onto said zirconium phosphate (ZrP) nanoplate(s).

2. The electrocatalyst as claimed in claim 1, wherein the Pt-nanoparticles are dispersed on the edges of the ZrP-nanoplates (Pt/ZrP), and/or on the overall surface of the ZrP-nanoplates (ZrP@Pt).

3. The electrocatalyst as claimed in claim 1, wherein the platinum (Pt) nanoparticles are present in a range of 35 to 45 wt. % and zirconium phosphate (ZrP) is present in a range of 65 to 55 wt. % of total composition of the electrocatalysts; and wherein the Zirconium (Zr) is present in a range of 31 to 35 wt. % of total wt. % of zirconium phosphate (ZrP).

4. The electrocatalyst as claimed in claim 1, wherein an average size of the Pt nanoparticles is in a range of 2.0-2.5 nm; and wherein an average diameter of the ZrP nanoplates is in a range of 300 to 800 nm and an edge length of the ZrP nanoplates is in a range of 35 nm to 50 nm.

5. The electrocatalyst as claimed in claim 1, wherein a proton conductivity of ZrP nanoplates is in a range of 0.26×10⁻⁴ S cm⁻¹ to 0.50×10⁻⁴ S cm⁻¹ at temperature in a range of 40 to 70° C. with an activation energy (Ea) of 0.19 eV.

6. A process for preparation of an electrocatalyst for proton exchange membrane (PEM) fuel cell, comprising:
a) adding and autoclaving a mixture of zirconium oxynitrate in phosphoric acid at a temperature in a range of 180 to 220° C. for a time period of 3-5 hours;
b) heating and solubilizing the mixture of step (a) for 3-9 minutes followed by centrifuging at a speed in a range of 6000 to 9000 rpm to obtain a cake;
c) washing the cake of step (b) with a deionized water followed by drying to obtain zirconium phosphate (ZrP);
d) dispersing the ZrP of step (c) in water under sonication followed by addition of Pt salt to obtain a suspension;
e) adding a solvent into the suspension of step (d) followed by sonication;
f) adding urea into the suspension of step (e) followed by heating and stirring to obtain a catalyst suspension; and
g) filtering out the catalyst suspension as obtained in step (f) followed by drying the residue to obtain the electrocatalyst for proton exchange membrane (PEM) fuel cell.

7. The process as claimed in claim 6, wherein the heating of step (b) is done at a temperature in a range of 180 to 230° C. for time period of 3 to 5 hours; and wherein the heating of step (f) is done at a temperature in a range of 35 to 120° C. for a time period of 1 to 24 hours.

8. The process as claimed in claim 6, wherein the drying of step (c) is done at a temperature in a range of 50 to 70° C. for a time period of 10 to 15 hours; and wherein the drying of step (g) is done at a temperature in a range of 60 to 80° C. for a time period of 10 to 15 hours.

9. The process as claimed in claim 6, wherein the sonication in step (d) is done for a time period of 5 to 10 minutes; and wherein the sonication in step (e) is done for a time period of 30 to 45 minutes.

10. The process as claimed in claim 6, wherein the Pt salt used in step (d) is selected from the group consisting of chloroplatinic acid hexahydrate (H₂PtCl₆·6H₂O), sodium tetrachloroplatinate (II) hydrate (Na₂PtCl₄·xH₂O), potassium tetrachloroplatinate (II) (K₂PtCl₄) and platinum tetrachloride (PtCl₄); and wherein the solvent used in step (e) is selected from the group consisting of ethylene glycol, propylene glycol and diethylene glycol.

11. A proton exchange membrane (PEM) fuel cell, comprising:
a) the electrocatalyst as claimed in claim 1, coated onto a gas diffusion layer (GDL),
b) a cathode,
c) an anode, and
d) a solid state electrolyte membrane placed between the cathode and anode.

12. The proton exchange membrane (PEM) fuel cell as claimed in claim 11, wherein the cathode is a material selected from platinum-carbon (Pt/C), platinum-trioxide (Pt/WO₃), platinum-nickel-carbon (Pt₃Ni/C), platinum-cobalt-carbon (Pt₃Co/C), and Pt-black;
wherein the anode is a material selected from Pt/C, Pt-black, platinum-ruthenium-carbon (PtRu/C), and Pt/WO₃; and the solid state electrolyte membrane is nafion.
